(19) United States
(12) Patent Application Publication
(10) Pub. No.: US 2025/0245996 A1
(43) Pub. Date: Jul. 31, 2025

(54) SYSTEMS AND METHODS FOR CONTAMINATION MONITORING AND CONTROL

(71) Applicant: Welch Allyn, Inc., Skaneateles Falls, NY (US)

(72) Inventors: John A. Lane, Skaneateles Falls, NY (US); David E. Quinn, Skaneateles Falls, NY (US); Gene J. Wolfe, Skaneateles Falls, NY (US); WonKyung McSweeney, Skaneateles Falls, NY (US); Danielle R. Endres, Skaneateles Falls, NY (US); Christopher Roedel, Skaneateles Falls, NY (US); Lucille Blain, Skaneateles Falls, NY (US)

(73) Assignee: Welch Allyn, Inc., Skaneateles Falls, NY (US)

(21) Appl. No.: 19/039,959

(22) Filed: Jan. 29, 2025

Related U.S. Application Data
(60) Provisional application No. 63/626,629, filed on Jan. 30, 2024.

(51) Int. Cl. G06V 20/52; G05B 15/02; G06V 10/62; G06V 40/20

(52) U.S. Cl. CPC G06V 20/52; G05B 15/02; G06V 10/62; G06V 40/20

(57) ABSTRACT

A contamination control system includes a processor; and a non-transitory, processor readable storage medium communicatively coupled to the processor, the non-transitory, processor readable storage medium including one or more instructions stored thereon that, when executed, cause the processor to: scan a room to obtain a reference image; detect occurrence of one or more triggering events based on one or more contamination identification processes; rescan the room to obtain a second image to determine a region of interest of contamination; compare the second image to the reference image; determine a change between the second image and the reference image; and control initiation of one or more reaction events.

### CROSS-REFERENCE TO RELATED APPLICATION

This application claims priority to U.S. Provisional Patent Application Ser. No. 63/626,629, filed Jan. 30, 2024, entitled, “SYSTEMS AND METHODS FOR CONTAMINATION MONITORING AND CONTROL,” the entirety of which is incorporated by reference herein.

### FIELD

The present disclosure generally relates to monitoring and control devices, and more particularly, to systems and methods for monitoring and controlling contamination of objects in a space.

### BACKGROUND

Monitoring of objects with infections in a space, such as a subject in a medical surgical room, is useful for achieving timely and optimal subject care. Infection control is more than just mere policies and procedures, as it is an important part of care for and protecting subjects. The absence of personnel (e.g., a nurse or assistant) within the space adds complexity, as the subject is not promptly attended to nor sufficiently monitored for receiving appropriate medication and care. Conventional techniques for implementing infection control use basic sterilization, hygiene, and protective equipment. However, when these techniques fail, it is no longer practical to detect potential exposure earlier to minimize damage.

### SUMMARY

In one aspect, a contamination control system may include a processor; and a non-transitory, processor readable storage medium communicatively coupled to the processor, the non-transitory, processor readable storage medium including one or more instructions stored thereon that, when executed, cause the processor to: obtain a reference image of a room; detect occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescan, via the plurality of imaging devices, the room to obtain a second image to determine a region of interest of contamination; compare the second image to the reference image; determine, based on the comparison, a change between the second image and the reference image; and control initiation of one or more reaction events responsive to the change.

In another aspect, a method to be performed by a processor of a computing device is provided. The method may include including: scanning a room to obtain a reference image; detecting occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescanning the room to obtain a second image to determine a region of interest of contamination; comparing the second image to the reference image; determining, based on the comparison, a change between the second image and the reference image; and controlling initiation of one or more reaction events responsive to the change.

In another aspect, a non-transitory, computer-readable medium including instructions that, when executed by at least one processor, cause the at least one processor to perform one or more operations including: scanning a room to obtain a reference image; detecting occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescanning the room to obtain a second image to determine a region of interest of contamination; comparing the second image to the reference image; determining, based on the comparison, a change between the second image and the reference image; and controlling initiation of one or more reaction events responsive to the change.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic diagram of an example contamination control system, according to one or more embodiments shown and described herein;

FIG. 2 depicts a schematic illustration of detected regions of interest of contamination using the contamination control system of FIG. 1, according to one or more embodiments shown and described herein; and

FIG. 3 depicts a flow diagram of an example method to be performed by the contamination control system of FIG. 1, according to one or more embodiments shown and described herein.

### DETAILED DESCRIPTION

The present disclosure relates to systems and methods for monitoring and control devices, and more particularly, to systems and methods for monitoring and controlling contamination of objects in a space. In particular, systems and methods disclosed herein provide a contamination control system that is configured to detect when potential contamination occurs and track its potential spread, both in real-time and also retrospectively from recording image data. Upon this detection and tracking, scanned images of a baseline and that of a contaminated region of interest are compared to determine not only changes between them, but also used to selectively control initiation of reaction events in response to the change. In this manner, the systems and methods disclosed herein are configured to visually discern cough and sneeze trajectories for any type of individual, as well as account for the propriety of barrier compliance, personal protective equipment compliance, sanitization compliance, and/or hygiene compliance for a specific space in accordance with space-specific infection control policies using a plurality of imaging devices. In this manner, the systems and methods disclosed herein identify, analyze, and control contamination spread, including accounting for real-time monitoring and tracking of the contamination spread using the plurality of imaging devices. By doing so, the system does not need to be actively monitored and/or need to be recording data by being powered on all the time, thereby reducing system computational load, increasing system operational efficiency, and reducing the likelihood of internal component failure (e.g., due to overuse).

While the present disclosure relates particularly to monitoring in a medical setting (e.g., real-time monitoring in medical surgical or subject rooms or the like), it should be understood that this is merely an example. That is, the systems and methods described herein may be used for or with any type of medical equipment, including, but not limited to, overhead lifts, vital monitoring equipment, control devices, wall-mounted displays, nurses station equipment, surgical equipment, furniture, wheelchairs, and the like. Further, the systems and methods described herein may be used for or with non-medical equipment such as, for example, office equipment such as printers, fax machines, communications equipment, manufacturing equipment, and the like. In addition, while the present disclosure relates specifically to medical facilities such as hospitals, physician offices, urgent care centers, clinics, and the like, it should be understood that this is merely an example. That is, the systems and methods described herein may be located in other locations outside of medical facilities, such as offices, factories, farms, and/or the like.

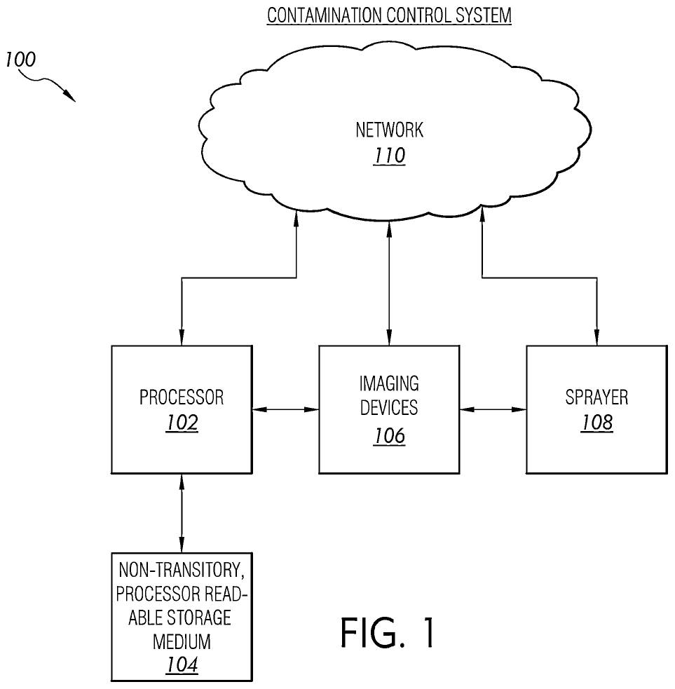

FIG. 1 depicts a schematic diagram of an illustrative contamination control system 100. The contamination control system 100 includes a processor 102, a non-transitory, processor readable storage medium 104, a plurality of imaging devices 106, a sprayer 108, and a network 110. Although FIG. 1 illustrates single instances of the constituent components of the contamination control system 100, the contamination control system 100 may include any number of constituent components. As depicted in FIG. 1, the various components of the contamination control system 100 are generally communicatively coupled to one another via the network 110, which may be, for example, a local network, an internet based network, and/or the like. In other embodiments, the various components of the contamination control system 100 may be communicatively coupled to one another via circuitry in the form of a bus, may be communicatively coupled to one another via direct connections, or the like.

The processor 102, such as a central processing unit (CPU), may be the central processing unit that is configured to perform calculations and logic operations to execute one or more programs. The processor 102, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor 102 may include any processing component configured to receive and execute instructions (such as from the non-transitory, processor readable storage medium 104). In some embodiments, the processor 102 may include a plurality of processing devices.

The non-transitory, processor readable storage medium 104 may contain one or more data repositories for storing data that is received and/or generated. The non-transitory, processor readable storage medium 104 may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory, processor readable storage medium 104 is depicted as a local device, it should be understood that the non-transitory, processor readable storage medium 104 may be a remote storage device, such as, for example, a server computing device, cloud-based storage device, or the like. The non-transitory, processor readable storage medium 104 may be communicatively coupled to the processor 102.

The plurality of imaging devices 106 may include, without limitation, a hyperspectral camera, a red, green, blue (RBG) camera, a thermal camera, an infrared camera, or any combination thereof. In certain embodiments, the plurality of imaging devices 106 may be configured to utilize fluorescent techniques, such as bacterial fluorescence, to identify any number of areas of interest or concern. In certain embodiments, the processor 102 may be configured to identify, via the plurality of imaging devices 106, one or more objects in a room. More specifically, the processor 102 may be configured to acquire imaging data from the plurality of imaging devices 106, analyze the imaging data (e.g., via one or more image recognition algorithms or the like), determine one or more objects located in the imaging data, and identify the one or more objects. By way of example and without limitation, the one or more objects identified may include any type of individual, a device, or a surface. For example, the processor 102 may be configured to distinguish between a patient and a clinician based on a band identifier, such as a wrist band, and/or a badge-based identification and/or based on detecting an outfit respectively worn by the patient and the clinician, which may utilize a classification system that is based on image input recognized by the processor 102 via the plurality of imaging devices 106. The processor 102 may be configured to compute a contamination probability for each of the one or more objects based on a plurality of parameters. In certain embodiments, the processor 102 may be configured to establish conditional probabilities of any number of infection events. The processor 102 may be aware of a set of one or more conditions to check for, and it may include utilization of a lookup table. The one or more conditions may include surface material, ventilation status, and the like. In certain embodiments, some of these may be a continuous factor, such as a duration of exposure, which may be discretized to apply the same approach, or a different method may be used to compute that. In certain embodiments, the processor 102 may be configured to establish a curve fit over the continuous factor. In certain embodiments, the plurality of parameters includes a posture of any type of individual, a direction of coughing and/or sneezing of any type of individual, the duration of coughing and/or sneezing particles in the air as well as a distance and trajectory traveled, use of personal protective equipment (including proper/improper placement), time elapsed since the coughing and/or sneezing by any type of individual, sterilization activities, preventative activities, or any combination thereof.

In certain embodiments, the sprayer 108 may include an atomizer or an ionizer that is configured to be controlled by the processor 102, such as, for example, by receiving signals from the processor 102, the signals directing the sprayer 108 to operate. For example, the sprayer 108 may be disseminate a predetermined amount of disinfectant that is applied to a site of contamination. It is understood that the sprayer 108 is not limited to spraying a liquid, and that any type of medium, such as a gas, a liquid, a solid, or any combination thereof, may be disseminated in any manner, such as a spray, an application, a disperser, a diffusion, or the like.

The network 110 may be one or more of a wireless network, a wired network or any combination of wireless network and wired network and may be configured to connect any of the components of the contamination control system 100. For example, the network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 110 may include, without limitation, telephone lines, fiber optics, IEEE Ethernet 802.3, a wide area network, a wireless personal area network, a LAN, or a global network such as the Internet. In addition, the network 110 may support an Internet network, a wireless communication network, a cellular network, or the like, or any combination thereof. The network 110 may further include one network, or any number of the exemplary types of networks mentioned above, operating as a stand-alone network or in cooperation with each other. The network 110 may utilize one or more protocols of one or more network elements to which they are communicatively coupled. The network 110 may translate to or from other protocols to one or more protocols of network devices. Although the network 110 is depicted as a single network, it should be appreciated that according to one or more examples, the network 110 may include a plurality of interconnected networks, such as, for example, the Internet, a service provider's network, a cable television network, corporate networks, such as credit card association networks, and home networks.

The processor 102 may be configured to scan, via the plurality of imaging devices 106, a room to obtain a reference image. The room may include a room where any number of individuals enter or exit. In certain embodiments, the individual may include a subject. In certain embodiments, the individual may include any other individual that is not a subject, including but not limited to a nurse, a physician assistant, a physician, a housekeeper, a physical therapist, a subject roommate, a phlebotomist, a worker, or a clinical technician. Prior to scanning the room to obtain the reference image, the room may be sanitized in accordance with one or more sanitization protocols specific to that room. It is understood that the plurality of imaging devices 106 are not limited to obtaining and transmitting only image data, and that video data, including but not limited to frame data, may also be obtained and transmitted by the plurality of imaging devices 106.

The processor 102 may be configured to detect occurrence of one or more triggering events based on one or more contamination identification processes after the subject arrives in the room. In certain embodiments, the one or more triggering events includes a contamination detection based on a sneeze, a cough, a lack of sanitization, a lack of personal protective equipment sanitization, a contagious touch, or any combination thereof. By way of example, a triggering event may include a nurse that sneezes or coughs without covering their mouth. In another example, a triggering event may include a nurse not sanitizing or wearing gloves prior to any type of touching. In yet another example, a triggering event may include a subject noted as sneezing or coughing without covering their mouth. In yet another example, a triggering event may include a subject noted as contagious and touching anything (excluding their bed) that any other type of individual, including but not limited to a nurse, may come in contact with. In certain embodiments, the subject may be known to be infected with a specific contaminant, and be manually specified. In other embodiments, data may indicate that the subject is known to be infected via their corresponding electronic medical record data.

In certain embodiments, the one or more contamination identification processes includes pixel content comparison, contrast determination, predetermined spectral frequencies evaluation, or any combination thereof. For example, the pixel content comparison may include comparing one or more pixels from a first image, such as the reference image, with one or more pixels from a second image, such as a different image than the reference image, so as to identify contamination. For example, contrast determination may include determining contrast visualization relative to a contaminated region of interest and a non-contaminated region of interest so as to identify contamination. In certain embodiments, the contrast determination may be performed by the processor 102 to find an index with sensitivity for the contaminated area detection. The contrast may be quantified by the processor 102 using a histogram analysis. In certain embodiments, at detection time, the processor 102 may be configured to analyze contrast distribution to determine if a change is detected. A type of expected change upon contamination may be understood in the contrast determination for contamination identification by the processor 102. For example, predetermined spectral frequencies evaluation may include evaluating certain frequencies of light to identify contamination. In certain embodiments, the contamination may include, without limitation, an infection or a disease.

The processor 102 may be configured to rescan, via the plurality of imaging devices 106, the room to obtain a second image (e.g., an image obtained at a later point in time, from a different perspective, and/or the like) to determine a region of interest of contamination. In certain embodiments, the room may be rescanned after detecting occurrence of the one or more triggering events based on the one or more contamination identification processes. The processor 102 may be configured to compare the second image to the reference image. The processor 102 may be configured to determine, based on the comparison, a change between the second image and the reference image.

The processor 102 may be configured to control initiation of one or more reaction events responsive to the change. In certain embodiments, the one or more reaction events include generation and output of an alert to a device, the alert being indicative of a probability of contamination. Without limitation, the device may include any type of device, such as a mobile device, associated with the subject or any other type of individual. By way of example, other types of devices may include a bedside monitor, a personal computer, a tablet, a wearable device, either located within the room and/or outside of the room. By way of example, a nurse may be alerted on their associated device of the contamination. In another example, a subject may be alerted on their associated device of the contamination. In yet another example, vital monitoring equipment may be alerted of the contamination. Without limitation, the alert may include an audible alert, a visual alert, or any combination thereof.

In certain embodiments, the one or more reaction events may include control of illumination on an affected area to mark a site of contamination. By way of example, a light source, such as a lamp or LED, may be controlled to illuminate light on the affected area to mark the site of contamination. In certain embodiments, the one or more reaction events may include control of illumination on an affected area to clean a site of contamination. By way of example, ultraviolet light may be illuminated on the affected area to clean the contamination.

In certain embodiments, the one or more reaction events may include control of disinfectant dissemination applied to an affected area. By way of example, the disinfectant dissemination may include spraying the disinfectant to the affected area by automatically controlling the sprayer 108, such as an atomizer or an ionizer, to disseminate a predetermined amount of the disinfectant. In another example, the disinfectant dissemination may include spraying the disinfectant to the affected area by controlling the sprayer 108 to disseminate the predetermined amount of the disinfectant at predetermined time intervals, such as every thirty seconds, every minute, every hour, etc. In certain embodiments, the one or more reaction events may include control of pressure within the room, such as creating a negative pressure room and maintaining it a desired pressure for tuberculosis.

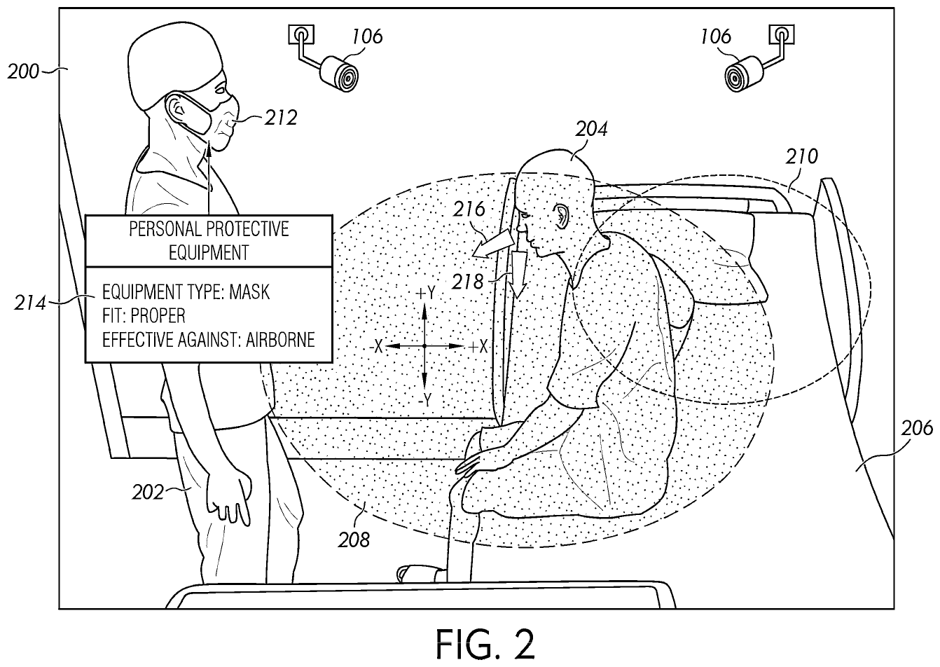

In certain embodiments, the one or more reaction events may include overlaying a first region of interest of contamination and a second region of interest of contamination onto a single image, including corresponding information associated with personal protective equipment, such as: a type of personal protective equipment; whether the personal protective equipment is properly fitted; and the type of contact transmissions that the personal protective equipment is effective against. It is understood that the overlaying of the first and second regions of interest of contamination need to be onto a single image, and that additional images may be used. Details regarding the overlaying the first and second regions of interest of contamination will be described further below with respect to FIG. 2.

Still further, the processor 102 may be configured to rescan, via the plurality of imaging devices 106, the room to establish a second reference image. As previously discussed, the processor 102 may be configured to detect occurrence of the one or more triggering events based on the one or more contamination identification processes. The processor 102 may be configured to rescan, via the plurality of imaging devices 106, the room to obtain a third image to determine a second region of interest of contamination. The processor 102 may be configured to compare the second reference image with the third image. The processor 102 may be configured to determine, based on the comparison, a second change between the second reference image and the third image. The processor 102 may be configured to control initiation of the one or more reaction events responsive to the second change.

In certain embodiments, the processor 102 may be configured to continuously monitor in real-time, via the plurality of imaging devices 106 and prior to the initiation of one or more reaction events, one or more room-specific infection control policies. By way of example, the one or more room-specific infection control policies include, upon entry and/or exit of the room by any type of the individual, pre-contact washing, post-contact washing, sterilization activities, barrier compliance, or any combination thereof. Without limitation, the one or more room-specific infection control policies may include not only washing hands with soap, but also for a proper duration, such as at least fifteen seconds, at a proper temperature (e.g., not with cold water), upon entry and exit of the subject or the nurse in the room. In certain embodiments, barrier compliance may include determining whether masks, gowns, and/or gloves are properly employed by a individual (other than the subject) and prior to contact with the subject, or any device or surface of the room. It is understood that the surface is not limited to that of the room, but can also include human skin surface, or any other type of surface.

The processor 102 may be configured to track, via the plurality of imaging devices 106, violations relative to any of the one or more room-specific infection control policies. By way of example, the processor 102 may be configured to determine the violations based on determining non-compliance of any of the one or more room-specific infection control policies. The processor 102 may be configured to control initiation of one or more reaction events responsive to the violations of any of the one or more room-specific infection control policies.

In certain embodiments, the processor 102 may be configured to track, via the plurality of imaging devices 106, a plurality of types of contamination transmission. By way of example, the contamination transmission may include airborne transmission, contact transmission, droplet transmission, or any combination thereof. For example, based on the type of contaminant transmission type, such as airborne, the processor may be configured to determine a tracking mode with a setting for the airborne transmission by the plurality of imaging devices. In addition, the processor 102 may be configured to de-identify the subject during tracking of potential contamination. By way of example, the subject may be given an obfuscated identifier in the contamination control system, where the mapping of the obfuscated identifier and the identify of the subject may be stored in a separate, secured location, and in certain embodiments, be only retrieved when needed. In certain embodiments, the processor 102 may be configured to generate and output a report for all identified objects including their corresponding computed probability of contamination.

FIG. 2 depicts a schematic illustration of detected regions of interest of contamination using the contamination control system of FIG. 1. FIG. 2 depicts a first individual 202, a second individual 204, and a plurality of regions of interest of contamination 208, 210 within a room 200. Although FIG. 2 illustrates single instances of the constituent components of the illustration, the illustration of FIG. 2 may include any number of constituent components. FIG. 2 may reference and incorporate any of the above constituent components and operations of the contamination control system 100 of FIG. 1.

As previously discussed with reference to FIG. 1, a processor (such as the processor 102) may be configured to control initiation of one or more reaction events responsive to a determined change between the second image and the reference image. In certain embodiments, the one or more reaction events may include overlaying a first region of interest of contamination and a second region of interest of contamination onto a single image.

Continuing with the above example, the processor 102 may be configured to identify objects, including the first individual 202, the second individual 204, and the subject bed 206, via a plurality of imaging devices, such as the plurality of imaging devices 106. As explained above, the processor 102 may be configured to identify not only whether the first individual 202 is wearing, for example, personal protective equipment 212, but also determine corresponding information 214 associated with the personal protective equipment 212 including but not limited to: a type of personal protective equipment, such as a mask; whether the personal protective equipment is properly fitted on the first individual 202; whether the personal protective equipment is an appropriate type and/or rating; and the type of contact transmissions that the personal protective equipment is effective against, such as airborne transmission. It is understood that the personal protective equipment 212 is not limited to only masks, and that other types of personal protective equipment 212 may be identified for proper fitting, such as gloves, gowns, shoe covers, head covers, masks, respirators, eye protection, face shields, and goggles.

The processor 102 may be configured to identify any number of regions of interest of contamination after detecting occurrence of one or more triggering events based on one or more contamination identification processes. As further depicted in FIG. 2, the processor 102 is configured to determine two regions of interest of contamination, such as a first region of interest of contamination 208 and a second region of interest of contamination 210. Regarding the first region of interest of contamination 208, the processor 102 is configured to identify the first region of interest of contamination 208 relative to the second individual 204. In certain embodiments, the processor 102 may be configured to identify the first region of interest of contamination 208 including the contamination transmission type, such as an airborne virus, as well as how long the airborne virus has stayed in the air, such as 0 minutes. Such identifications by the processor 102 may be indicative of, for example, not only a recent sneeze and/or a cough by the second individual 204, but also the duration of associated sneeze and/or cough particles in the air. Moreover, the processor 102 may be configured to determine a magnitude and a direction 216 of a cough by the second individual 204 and/or a magnitude and a direction 218 of a sneeze by the second individual 204 relative to the mouth of the second individual 204 and the nose of the second individual 204, respectively. While the direction 216 of the cough and the direction 218 of the sneeze are illustrated with respect to the −X and −Y axes, it is understood that these directions are not limited to such, and that any other direction may be used. Still further, the processor 102 may be configured to label this first region of interest of contamination 208 as a first contaminated area, and overlay this first contaminated area onto an image, as depicted in FIG. 2.

Regarding the second region of interest of contamination 210, the processor 102 may be configured to identify this region relative to the second individual 204 and the subject bed 206. In certain embodiments, the region may be identified relative to a vicinity of the subject bed 206. For example, the processor 102 may be configured to determine the second region of interest of contamination 210 including the contamination transmission type, such as the airborne virus, as well as how long the airborne virus has stayed in the air, such as, for example, six minutes out of ten minutes. As with the first region of interest of contamination 208, such identifications by the processor 102 may be indicative of, for example, not only a recent sneeze and/or a cough by the second individual 204, but also the duration of associated sneeze and/or cough particles in the air. Still further, the processor 102 may be configured to label this second region of interest of contamination 210 as a second contaminated area, and overlay this second contaminated area onto an image alongside the first region of interest of contamination 208 including the first contaminated area, as depicted in FIG. 2.

In certain embodiments, the labeled first region of interest of contamination 208 as a first contaminated area and the labeled second region of interest of contamination 210 as a second contaminated area that are overlaid onto a single image may be denoted by different shapes, colors, sizes, texts, symbols, or any other representation generated by the processor 102. In this manner, the first contaminated area and the second contaminated area may be sufficiently distinguished each other when viewed for display by the processor 102.

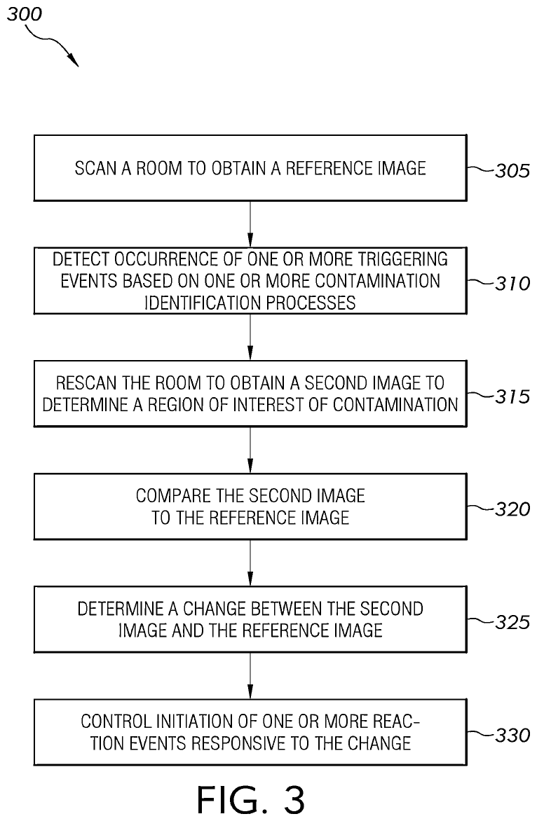

FIG. 3 depicts a flow diagram of an example method 300 that is performed by the contamination control system of FIGS. 1-2. The method 300 may include monitoring and controlling contamination in a room. FIG. 3 may reference and incorporate any of the above constituent components and operations of the contamination control system 100 of FIGS. 1-2. As explained above, the contamination control system 100 may include a processor 102 that is communicatively coupled to a non-transitory, processor readable storage medium 104. For purposes of brevity, the below blocks for the method 300 may be carried out with reference to the constituent components and operations of the contamination control system 100 previously explained with reference to FIGS. 1-2.

At block 305, the non-transitory, processor readable storage medium 104 may include one or more instructions stored thereon that, when executed, cause the processor 102 to scan a room to obtain a reference image. That is, the processor 102 may instruct a plurality of imaging devices to obtain images and transmit image data corresponding thereto to the processor 102. Alternatively or additionally, the plurality of imaging devices may be configured to obtain and transmit the image data in a predetermined frequent manner, such as a periodic manner, a continuous manner, or any combination thereof, to a database and/or a server and/or the processor 102, any and all of which may be respectively configured to analyze the image data as disclosed herein. In certain embodiments, the processor 102 may then utilize the obtained image data to generate a reference image (e.g., by stitching a plurality of images together, labeling elements in the image data, and/or the like).

At block 310, the non-transitory, processor readable storage medium 104 may include one or more instructions stored thereon that, when executed, cause the processor 102 to detect occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof. Such a detection may generally be completed by analyzing the image data for characteristics that correspond to a triggering event. The characteristics may be obtained from a database, may be determined via machine learning, and/or the like.

At block 315, the non-transitory, processor readable storage medium 104 may include one or more instructions stored thereon that, when executed, cause the processor 102 to rescan the room to obtain a second image to determine a region of interest of contamination.

At block 320, the non-transitory, processor readable storage medium 104 may include one or more instructions stored thereon that, when executed, cause the processor 102 to compare the second image to the reference image. Comparing may generally include analyzing both images to determine differences between the images and characterizing or labeling the differences.

At block 325, the non-transitory, processor readable storage medium 104 may include one or more instructions stored thereon that, when executed, cause the processor 102 to determine, based on the comparison, a change between the second image and the reference image; and

At block 330, the non-transitory, processor readable storage medium 104 may include one or more instructions stored thereon that, when executed, cause the processor 102 to control initiation of one or more reaction events responsive to the change. For example, one or signals may be transmitted to control components, an alert may be provided, and/or the like.

The present disclosure relates to systems and methods for monitoring and control devices, and more particularly, to systems and methods for monitoring and controlling contamination of objects in a space. In particular, systems and methods disclosed herein provide a contamination control system that is configured to detect when potential contamination occurs, and track its potential spread, both in real-time and also retrospectively from recording image data. Upon this detection and tracking, scanned images of a baseline and that of a contaminated region of interest are compared to determine not only changes between them, but also used to selectively control initiation of reaction events in response to the change. In this manner, the systems and methods disclosed herein are configured to visually discern cough and sneeze trajectories for any type of individual, as well as account for the propriety of barrier compliance, personal protective equipment compliance, sanitization compliance, and hygiene compliance for a specific space in accordance with space-specific infection control policies using a plurality of imaging devices. In this manner, the systems and methods disclosed herein identify, analyze, and control contamination spread, including accounting for real-time monitoring and tracking of the contamination spread. By doing so, the system does not need to be actively monitoring or recording data all the time, thereby reducing system computational load and increasing system operational efficiency.

Further aspects of the disclosure are provided by the subject matter of the following clauses.

A contamination control system, including: a processor; and a non-transitory, processor readable storage medium communicatively coupled to the processor, the non-transitory, processor readable storage medium including one or more instructions stored thereon that, when executed, cause the processor to: scan, via a plurality of imaging devices communicatively coupled with the processor, a room to obtain a reference image; detect occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescan, via the plurality of imaging devices, the room to obtain a second image to determine a region of interest of contamination; compare the second image to the reference image; determine, based on the comparison, a change between the second image and the reference image; and control initiation of one or more reaction events responsive to the change.

The contamination control system of any preceding clause, wherein obtaining the reference image of the room comprises scanning, via a plurality of imaging devices, the room.

The contamination control system of any preceding clause, wherein the one or more instructions further cause the processor to: rescan, via the plurality of imaging devices, the room to establish a second reference image; detect occurrence of the one or more triggering events based on the one or more contamination identification processes; rescan, via the plurality of imaging devices, the room to obtain a third image to determine a second region of interest of contamination; compare the second reference image with the third image; determine, based on the comparison, a second change between the second reference image and the third image; and control initiation of the one or more reaction events responsive to the second change.

The contamination control system of any preceding clause, wherein the one or more contamination identification processes includes pixel content comparison, contrast determination, or predetermined spectral frequencies evaluation.

The contamination control system of any preceding clause, wherein the one or more reaction events include generation and output of an alert to a device, the alert being indicative of a probability of contamination.

The contamination control system of any preceding clause, wherein the one or more reaction events include control of illumination on an affected area to mark a site of contamination.

The contamination control system of any preceding clause, wherein the one or more reaction events include control of illumination on an affected area to clean a site of contamination.

The contamination control system of any preceding clause, wherein the one or more reaction events include control of disinfectant dissemination applied to an affected area.

The contamination control system of any preceding clause, wherein the disinfectant dissemination includes spraying the disinfectant to the affected area by controlling an atomizer or an ionizer to: disseminate a predetermined amount of the disinfectant, or disseminate the predetermined amount of the disinfectant at predetermined time intervals.

The contamination control system of any preceding clause, wherein the one or more instructions further cause the processor to: identify, via the plurality of imaging devices, one or more objects in the room; and compute a contamination probability for each of the one or more objects based on a plurality of parameters.

The contamination control system of any preceding clause, wherein the plurality of parameters includes a posture, a direction of coughing or sneezing, personal protective equipment, time elapsed since the coughing or sneezing, sterilization activities, or any combination thereof.

The contamination control system of any preceding clause, wherein the one or more instructions further cause the processor to: track, via the plurality of imaging devices and prior to the initiation of one or more reaction events, one or more room-specific infection control policies; track, via the plurality of imaging devices, violations relative to any of the one or more room-specific infection control policies; and control initiation of one or more reaction events responsive to the violations of any of the one or more room-specific infection control policies.

The contamination control system of any preceding clause, wherein the one or more room-specific infection control policies include, upon entry or exit of the room, pre-contact washing, post-contact washing, sterilization activities, barrier compliance, or any combination thereof.

The contamination control system of any preceding clause, wherein the one or more instructions further cause the processor to track, via the plurality of imaging devices, a plurality of types of contamination transmission including airborne transmission, contact transmission, and droplet transmission.

A method, including: scanning a room to obtain a reference image; detecting occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescanning the room to obtain a second image to determine a region of interest of contamination; comparing the second image to the reference image; determining, based on the comparison, a change between the second image and the reference image; and controlling initiation of one or more reaction events responsive to the change.

The method of any preceding clause, wherein obtaining the reference image of the room comprises scanning the room.

The method of any preceding clause, further including: rescanning the room to establish a second reference image; detecting occurrence of the one or more triggering events based on the one or more contamination identification processes; rescanning the room to obtain a third image to determine a second region of interest of contamination; comparing the second reference image with the third image; determining, based on the comparison, a second change between the second reference image and the third image; and controlling initiation of the one or more reaction events responsive to the second change.

The method of any preceding clause, wherein the one or more contamination identification processes includes pixel content comparison, contrast determination, or predetermined spectral frequencies evaluation.

The method of any preceding clause, wherein the one or more reaction events include generation and output of an alert to a device, the alert being indicative of a probability of contamination.

The method of any preceding clause, wherein the one or more reaction events include control of illumination on an affected area to mark a site of contamination.

The method of any preceding clause wherein the one or more reaction events include control of illumination on an affected area to clean a site of contamination.

The method of any preceding clause, wherein the one or more reaction events include control of disinfectant dissemination applied to an affected area.

The method of any preceding clause, wherein the disinfectant dissemination includes spraying the disinfectant to the affected area by controlling an atomizer or an ionizer to: disseminating a predetermined amount of the disinfectant, or disseminating the predetermined amount of the disinfectant at predetermined time intervals.

The method of any preceding clause, further including: identifying one or more entities in the room; and computing a contamination probability for each of the one or more entities based on a plurality of parameters.

The method of any preceding clause, wherein the plurality of parameters includes a posture, a direction of coughing or sneezing, personal protective equipment, time elapsed since the coughing or the sneezing, sterilization activities, or any combination thereof.

The method of any preceding clause, further including: tracking prior to the initiation of one or more reaction events, one or more room-specific infection control policies; tracking violations relative to any of the one or more room-specific infection control policies; and controlling initiation of one or more reaction events responsive to the violations of any of the one or more room-specific infection control policies.

The method of any preceding clause, wherein the one or more room-specific infection control policies include, upon entry or exit of the room, pre-contact washing, post-contact washing, sterilization activities, barrier compliance, or any combination thereof.

The method of any preceding clause, further including tracking a plurality of types of contamination transmission including airborne transmission, contact transmission, and droplet transmission.

A non-transitory, computer-readable medium including instructions that, when executed by at least one processor, cause the at least one processor to perform one or more operations including: scanning a room to obtain a reference image; detecting occurrence of one or more triggering events based on one or more contamination identification processes, wherein the one or more triggering events includes a contamination detection based on a sneeze, a cough, a lack of sanitization, a lack of personal protective equipment sanitization, a contagious touch, or any combination thereof; rescanning the room to obtain a second image to determine a region of interest of contamination; comparing the second image to the reference image; determining, based on the comparison, a change between the second image and the reference image; and controlling initiation of one or more reaction events responsive to the change.

The non-transitory, computer-readable medium of any preceding clause, wherein obtaining the reference image of the room comprises scanning the room.

The non-transitory, computer-readable medium of any preceding clause, the one or more operations further including: rescanning the room to establish a second reference image; detecting occurrence of the one or more triggering events based on the one or more contamination identification processes; rescanning the room to obtain a third image to determine a second region of interest of contamination; comparing the second reference image with the third image; determining, based on the comparison, a second change between the second reference image and the third image; and controlling initiation of the one or more reaction events responsive to the second change.

The non-transitory, computer-readable medium of any preceding clause, wherein the one or more contamination identification processes includes pixel content comparison, contrast determination, or predetermined spectral frequencies evaluation.

The non-transitory, computer-readable medium of any preceding clause, wherein the one or more reaction events include generation and output of an alert to a device, the alert being indicative of a probability of contamination.

The non-transitory, computer-readable medium of any preceding clause, wherein the one or more reaction events include control of illumination on an affected area to mark a site of contamination.

The non-transitory, computer-readable medium of any preceding clause, wherein the one or more reaction events include control of illumination on an affected area to clean a site of contamination.

The non-transitory, computer-readable medium of any preceding clause, wherein the one or more reaction events include control of disinfectant dissemination applied to an affected area.

The non-transitory, computer-readable medium of any preceding clause, wherein the disinfectant dissemination includes spraying the disinfectant to the affected area by controlling an atomizer or an ionizer to: disseminating a predetermined amount of the disinfectant, or disseminating the predetermined amount of the disinfectant at predetermined time intervals.

The non-transitory, computer-readable medium of any preceding clause, the one or more operations further including: identifying one or more entities in the room; and computing a contamination probability for each of the one or more entities based on a plurality of parameters.

The non-transitory, computer-readable medium of any preceding clause, wherein the plurality of parameters includes a posture, a direction of coughing or sneezing, personal protective equipment, time elapsed since the coughing or the sneezing, sterilization activities, or any combination thereof.

The non-transitory, computer-readable medium of any preceding clause, the one or more operations further including: tracking, prior to the initiation of one or more reaction events, one or more room-specific infection control policies; tracking violations relative to any of the one or more room-specific infection control policies; and controlling initiation of one or more reaction events responsive to the violations of any of the one or more room-specific infection control policies.

The non-transitory, computer-readable medium of any preceding clause, wherein the one or more room-specific infection control policies include, upon entry or exit of the room, pre-contact washing, post-contact washing, sterilization activities, barrier compliance, or any combination thereof.

The non-transitory, computer-readable medium of any preceding clause, the one or more operations further including tracking a plurality of types of contamination transmission including airborne transmission, contact transmission, and droplet transmission.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A contamination control system, comprising:
a processor; and
a non-transitory, processor readable storage medium communicatively coupled to the processor, the non-transitory, processor readable storage medium comprising one or more instructions stored thereon that, when executed, cause the processor to:
obtain a reference image of a room;
detect occurrence of one or more triggering events based on one or more contamination identification processes, wherein the one or more triggering events comprises a contamination detection based on a sneeze, a cough, a lack of sanitization, a lack of personal protective equipment sanitization, a contagious touch, or any combination thereof;
rescan, via the plurality of imaging devices, the room to obtain a second image to determine a region of interest of contamination;
compare the second image to the reference image;
determine, based on the comparison, a change between the second image and the reference image; and
control initiation of one or more reaction events responsive to the change.

2. The contamination control system of claim 1, wherein obtaining the reference image of the room comprises scanning, via a plurality of imaging devices, the room.

3. The contamination control system of claim 2, wherein the one or more instructions further cause the processor to:
rescan, via the plurality of imaging devices, the room to establish a second reference image;
detect occurrence of the one or more triggering events based on the one or more contamination identification processes;
rescan, via the plurality of imaging devices, the room to obtain a third image to determine a second region of interest of contamination;
compare the second reference image with the third image;
determine, based on the comparison, a second change between the second reference image and the third image; and
control initiation of the one or more reaction events responsive to the second change.

4. The contamination control system of claim 1, wherein the one or more contamination identification processes comprises pixel content comparison, contrast determination, or predetermined spectral frequencies evaluation.

5. The contamination control system of claim 1, wherein the one or more reaction events include generation and output of an alert to a device, the alert being indicative of a probability of contamination.

6. The contamination control system of claim 1, wherein the one or more reaction events include control of illumination on an affected area to indicate a site of contamination.

7. The contamination control system of claim 1, wherein the one or more reaction events include control of illumination on an affected area to clean a site of contamination.

8. The contamination control of claim 1, wherein the one or more reaction events include control of disinfectant dissemination applied to an affected area.

9. The contamination control system of claim 8, wherein the disinfectant dissemination comprises spraying the disinfectant to the affected area by controlling an atomizer or an ionizer to:
disseminate a predetermined amount of the disinfectant, or
disseminate the predetermined amount of the disinfectant at predetermined time intervals.

10. The contamination control system of claim 1, wherein the one or more instructions further cause the processor to:
identify, via the plurality of imaging devices, one or more objects in the room; and
compute a contamination probability for each of the one or more objects based on a plurality of parameters.

11. The contamination control system of claim 10, wherein the plurality of parameters comprises a posture, a direction of coughing or sneezing, personal protective equipment, time elapsed since the coughing or sneezing, sterilization activities, or any combination thereof.

12. The contamination control system of claim 1, wherein the one or more instructions further cause the processor to:
track, via the plurality of imaging devices and prior to the initiation of one or more reaction events, one or more room-specific infection control policies;
track, via the plurality of imaging devices, violations relative to any of the one or more room-specific infection control policies; and
control initiation of one or more reaction events responsive to the violations of any of the one or more room-specific infection control policies.

13. The contamination control system of claim 12, wherein the one or more room-specific infection control policies include, upon entry or exit of the room, pre-contact washing, post-contact washing, sterilization activities, barrier compliance, or any combination thereof.

14. The contamination control system of claim 1, wherein the one or more instructions further cause the processor to track, via the plurality of imaging devices, a plurality of types of contamination transmission including airborne transmission, contact transmission, and droplet transmission.

15. A method, comprising:
obtaining a reference image of a room;
detecting occurrence of one or more triggering events based on one or more contamination identification processes, wherein the one or more triggering events comprises a contamination detection based on a sneeze, a cough, a lack of sanitization, a lack of personal protective equipment sanitization, a contagious touch, or any combination thereof;
rescanning the room to obtain a second image to determine a region of interest of contamination;
comparing the second image to the reference image;
determining, based on the comparison, a change between the second image and the reference image; and
controlling initiation of one or more reaction events responsive to the change.

16. The method of claim 15, wherein obtaining the reference image of the room comprises scanning the room.

17. The method of claim 16, further comprising:
rescanning the room to establish a second reference image;
detecting occurrence of the one or more triggering events based on the one or more contamination identification processes;
rescanning the room to obtain a third image to determine a second region of interest of contamination;
comparing the second reference image with the third image;
determining, based on the comparison, a second change between the second reference image and the third image; and
controlling initiation of the one or more reaction events responsive to the second change.

18. The method of claim 15, wherein the one or more contamination identification processes comprises pixel content comparison, contrast determination, or predetermined spectral frequencies evaluation.

19. The method of claim 15, wherein the one or more reaction events include generation and output of an alert to a device, the alert being indicative of a probability of contamination.

20. A non-transitory computer-readable medium comprising instructions that, when executed by at least one processor, cause the at least one processor to perform one or more operations comprising:
obtaining a reference image of a room;
detecting occurrence of one or more triggering events based on one or more contamination identification processes, wherein the one or more triggering events comprises a contamination detection based on a sneeze, a cough, a lack of sanitization, a lack of personal protective equipment sanitization, a contagious touch, or any combination thereof;
rescanning the room to obtain a second image to determine a region of interest of contamination;
comparing the second image to the reference image;
determining, based on the comparison, a change between the second image and the reference image; and
controlling initiation of one or more reaction events responsive to the change.
